(19) United States
(12) Patent Application Publication
(10) Pub. No.: US 2024/0110600 A1
(43) Pub. Date: Apr. 4, 2024

(54) ADAPTER FOR TORQUE TRANSMISSION BETWEEN TWO ROTATABLE COMPONENTS

(71) Applicant: ATLAS COPCO COMPTEC, LLC, VOORHEESVILLE, NY (US)

(72) Inventors: Kyle Richard Boyd, Glenmont, NY (US); Ross Morgan Snyder, Schenectady, NY (US); Jeffrey Russell Whitehouse, Clifton Park, NY (US)

(21) Appl. No.: 18/478,362

(22) Filed: Sep. 29, 2023

Related U.S. Application Data
(60) Provisional application No. 63/413,048, filed on Oct. 4, 2022.

(51) Int. Cl. F16D 1/08; F01D 5/06

(52) U.S. Cl. CPC F16D 1/087; F01D 5/066

(57) ABSTRACT

An adapter for torque transmission between a first rotatable component and a second rotatable component is provided. The adapter includes a first torque transmission feature configured to transmit torque between the adapter and the first rotatable component, and a second torque transmission feature configured to transmit torque between the adapter and the second rotatable component, the second torque transmission feature being different than the first torque transmission feature.

### CROSS-REFERENCE TO RELATED APPLICATIONS

This application claims the benefit of and priority to U.S. Provisional Application No. 63/413,048, filed Oct. 4, 2022, and entitled “Adapter for Torque Transmission Between Two Rotatable Components.”

### FIELD OF TECHNOLOGY

The following relates to embodiments of an adapter for torque transmission between rotatable components, and more specifically to embodiments of an adapter, an assembly including the adapter, and a method.

### BACKGROUND

Conventional torque transmission between rotatable components of a turbomachine is done by either a precision friction connection or radial tooth joint directly between the rotatable components.

### SUMMARY

An aspect relates to an adapter for torque transmission between a first rotatable component and a second rotatable component, the adapter comprising: a first torque transmission feature configured to transmit torque between the adapter and the first rotatable component; and a second torque transmission feature configured to transmit torque between the adapter and the second rotatable component, the second torque transmission feature being different than the first torque transmission feature.

In an exemplary embodiment, the first torque transmission feature is a precision friction connection. In other embodiments, the first torque transmission feature is a keyed connection, an axial spline, one or more pins, a taper, or a polygonal connection. The first torque transmission feature is located at a first end of the adapter that is proximate the first rotatable component in an assembled configuration.

In an exemplary embodiment, the second torque transmission feature is a radial tooth joint, known in art as a Hirth joint. The second torque transmission feature is located at a second end, opposite the first end, which is proximate the second rotatable component.

In an exemplary embodiment, the adapter includes a first annular body portion having a diameter and including an outer surface extending in an axial direction, and an end face extending in a radial direction that faces the first rotatable component, wherein the first torque transmission feature is located on the end face, and a second annular body portion having a diameter different than the diameter of the first annular body portion, and including an outer surface extending in the axial direction, and an end face extending in the radial direction that faces the second rotatable component, wherein the second torque transmission feature is located on the end face.

Another aspect relates to an assembly including a first rotatable component, a second rotatable component operably coupled to the first rotatable component, and adapter disposed between the first rotatable component and the second rotatable component to transmit torque therebetween, the adapter having a first torque transmission feature located at a first end of the adapter that is proximate the first rotatable component, and a second torque transmission feature located at a second end of the adapter that is proximate the second rotatable component, wherein the first torque transmission feature is different than the second torque transmission feature. The assembly includes a tie bolt insertable through the first rotatable component to secure the adapter in place between the first rotatable component and the second rotatable component.

In some configurations of the assembly, a shim is disposed between the first end of the adapter and the first rotatable component, the shim configured to cooperate with the first torque transmission feature to transmit torque from the adapter to the first rotatable component. In further configurations of the assembly, an additional rotatable component is operably coupled to the second rotatable component at a distal end of the second rotatable component from the first rotatable component. In further configurations of the assembly, an additional adapter is disposed between the distal end of the second rotatable component and the additional rotatable component.

Another aspect relates to a disposing an adapter between a first rotatable component and a second rotatable component for transmitting torque between the first rotatable component and the second rotatable component, the adapter including a first torque transmission feature located at a first end of the adapter that is proximate the first rotatable component, and a second torque transmission feature located at a second end of the adapter that is proximate the second rotatable component, wherein the first torque transmission feature is different than the second torque transmission feature.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a known technique of a precision friction connection directly between a shaft and an impeller;

FIG. 2 depicts the use of a shim in conjunction with the precision friction connection of FIG. 1;

FIG. 3 depicts a known technique of a radial tooth joint directly between a shaft and an impeller;

FIG. 4 depicts a schematic view of a rotor assembly having rotatable components, according to embodiments of the present invention;

FIG. 5 depicts a schematic view of a first rotatable component of the rotor assembly, in accordance with embodiments of the present invention;

FIG. 6A depicts a schematic view of a second rotatable component of the rotor assembly, in accordance with embodiments of the present invention;

FIG. 6B depicts a cross-sectional view of the second rotatable component, in accordance with embodiments of the present invention;

FIG. 7A depicts a schematic view of the adapter of the rotor assembly, in accordance with embodiments of the present invention;

FIG. 7B depicts a cross-sectional view of an adapter, in accordance with embodiments of the present invention;

FIG. 8A depicts an end view of the adapter, showing an embodiment of the first torque transmission feature, in accordance with embodiments of the present invention;

FIG. 8B depicts an end view of the adapter depicted in FIG. 7B, showing a first embodiment of the first torque transmission feature, in accordance with embodiments of the present invention

FIG. 9A depicts an end view of the adapter, showing the second torque transmission feature, in accordance with embodiments of the present invention;

FIG. 9B depicts an end view of the adapter depicted in FIG. 7B, showing the second torque transmission feature, in accordance with embodiments of the present invention;

FIG. 10 depicts a cross-sectional view of a compressor assembly including the adapter, in accordance with embodiments of the present invention;

FIG. 11 depicts a schematic view of a rotor assembly including the adapter and a shim, in accordance with embodiments of the present invention;

FIG. 12 depicts a cross-sectional view of a compressor assembly including the adapter and the shim, in accordance with embodiments of the present invention;

FIG. 13 depicts a schematic view of a rotor assembly 104 including the adapter 30, with an additional rotatable component, in accordance with embodiments of the present invention;

FIG. 14 depicts a schematic view of a rotor assembly 105 including the adapter 30 with an additional rotatable component 10′ and a shim 50 on one side of the rotor assembly 105, in accordance with embodiments of the present invention;

FIG. 15 depicts a schematic view of a rotor assembly including two adapters, one of each side of the rotor assembly 106, in accordance with embodiments of the present invention;

FIG. 16 depicts a schematic view of a rotor assembly 107 including two adapters 30, 30′, one of each side of the assembly 107, and a shim 50 on one side of the assembly 107, in accordance with embodiments of the present invention;

FIG. 17 depicts a schematic view of a rotor assembly 108 including an adapter 330 according to an alternative embodiment; and

FIG. 18 depicts a cross-sectional view of a compressor assembly including the adapter according to alternative embodiments.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

In brief overview, machines that impart or extract energy from a moving fluid, such as a turbomachine, utilize rotatable components that either drive another rotatable component or are driven by another rotatable component. Examples of a turbomachine include a compressor, an expander, a turbine, a pump, and various subcategories of these machines. The rotatable components are mechanically connected to transmit torque therebetween. Embodiments of the invention relate to improving the mechanical connection between two rotatable components.

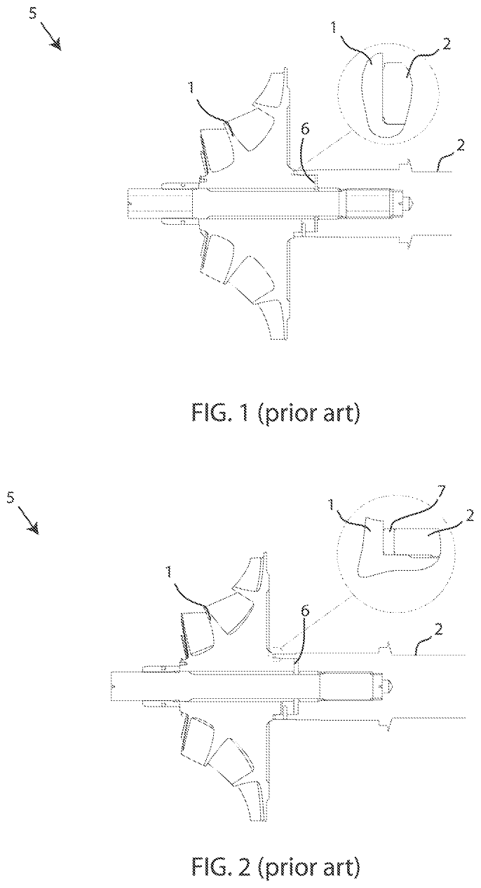

FIG. 1 depicts a known mechanical connection directly between two rotatable components. In the illustrated embodiment, the two rotatable components are an impeller 1 and a shaft 2 of a centrifugal compressor 5. The impeller 1 is mounted to the shaft 2 to draw gas into the compressor for gas compression. High-speed rotation of the shaft 2 causes high speed rotation of the impeller 1 to add velocity to the gas flowing through the impeller 1 into the compressor 5. The mechanical connection between the impeller 1 and the shaft 2 ensures proper torque transmission from the shaft 2 to the impeller 1. A first known torque transmission feature to transmit torque from the shaft 2 to the impeller 1 is a precision friction connection. The precision friction connection is a direct engagement between the shaft 2 and the impeller 1 using surface features on the shaft 2 that cooperate and/or mate with surface features on the impeller 1. Examples of a precision friction fit/connection are microsplines. A second known torque transmission feature to transmit torque from the shaft 2 to the impeller 1 is a traditional mechanical connection, such as axial splines, keys, pins, and the like, which mechanically engage each other to transmit torque directly between the shaft 2 and the impeller 1.

FIG. 1 depicts a known precision friction connection directly between the shaft 2 and the impeller 1. The impeller 1 engages the shaft 2 directly and utilizes a microspline at a friction face location to establish a precision friction connection 6 FIG. 2 depicts the use of a shim 7 in conjunction with the precision friction connection of FIG. 1. The precision friction connection allows the use of a shim 7 at the impeller 1 to achieve desired impeller clearances (e.g. between surface of impeller and an aerodynamically shaped component, such as a shroud). The use of a shim 7 at this ideal location eliminates a need to remove a housing (e.g. compressor housing) for clearance adjustment. Further, compressor damage is limited if the rotating impeller 1 comes into hard contact with a shroud; no axial forces are created by the friction connection and typically only the impeller 1 and shroud see significant damage if such contact were to occur.

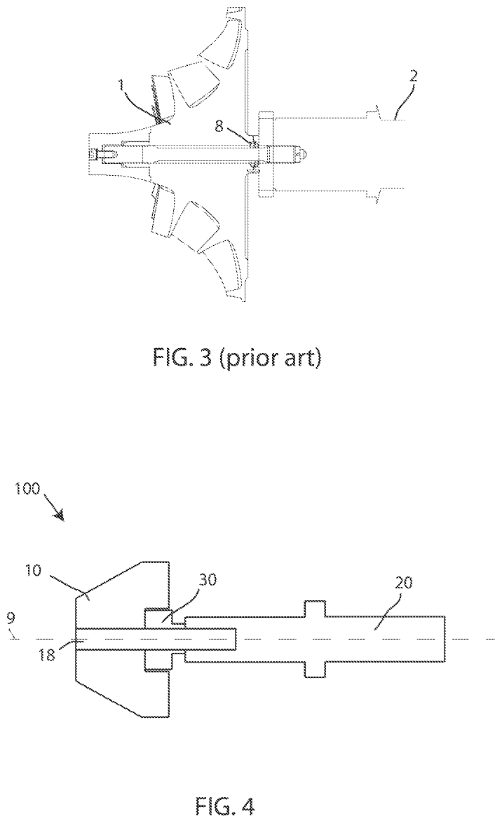

However, microsplines require shaft diameters that are often too large to be used with an optimally sized shaft seal resulting in more expensive and less efficient gas seals and sometimes requires a larger gearbox. For instance, a microspline connection often precludes the use of cartridge style dry gas seals because the seal retaining nut must be smaller than the hydraulic diameter of the dry gas seal. In cases where a smaller shaft diameter is desired, a second known torque transmission feature, a radial tooth joint, is used to transmit torque from the shaft to the impeller. A radial tooth joint, or Hirth joint, is utilized due to its smaller diameter when compared to a microspline of equal load carrying capacity. FIG. 3 depicts a known technique of a radial tooth joint 8 directly between the shaft 2 and the impeller 1. The impeller 1 includes radial teeth serrations which engage corresponding radial teeth serrations on the shaft 2 to establish a radial tooth joint 8 directly between the shaft 2 and the impeller 1.

While a radial tooth joint is suitable for ensuring proper torque transmission between two rotatable components, the use of a radial tooth joint presents assembly challenges, for example, when a double ended rotor is required. The impeller clearances on one side of the rotor can be adjusted using bearing shims; however, the clearances on the other side of the rotor can only be adjusted by shimming the compressor housing. In some cases, both compressor housings may be shimmed with the bearing fixed axially Due to the physical size of the housing, this increases assembly time and increases safety risks to the assemblers. In other words, the use of a radial tooth joint directly between the shaft and the impeller does not afford the use of shims in ideal locations (e.g. directly between a surface of the shaft and a surface of the impeller) that allow for convenient adjustment of the axial length of the rotor.

Radial tooth joints directly between two rotatable components of a turbomachine, such as the shaft and the impeller have additional drawbacks. Should the rotating impeller come into hard contact with the shroud significant axial forces are generated due to the geometry of the serrated teeth of the radial tooth joint. This can result in significant gearing damage, as well as a liberation of high energy projectiles as the housing and/or shroud bolts fail. The potential for damage puts operators in proximity to the operating compressor at increased risk of injury during such an event.

Embodiments of the present invention provide a solution to the drawbacks of the precision friction connection and the radial tooth joint directly between two rotatable components. Instead of direct engagement between rotatable components, an adapter is disposed therebetween. Torque is transmitted between the rotatable components in some cases from a shaft to the adapter and from the adapter to an impeller, and in other cases from an impeller to the adapter and from the adapter to the shaft. The adapter leverages the advantages of the radial teeth serration connection (e.g. smaller diameter) on one side between the adapter and the shaft, and leverages the advantages of the precision friction connection (e.g. ability to shim for axial adjustment without needing to shim impeller housing or remove housing) on the opposing side between the adapter and the impeller. Further advantages of the adapter include reduced labor time during assembly and increased safety due to reduced handling of very large and heavy components. Depending on the method of torque transmission between the impeller and the adapter, a less destructive failure mode is likely should the rotating impeller come into hard contact with the shroud. The adapter can act as a torque limiting coupling, greatly limiting compressor damage and increase the safety of operators near the compressor during such a failure. Moreover, the adapter can be attached using only a conventional tie-bolt; no other screws or bolts are necessary. The reduced hardware provides better high-speed balance and simplified installation/design compared to other couplings. In some cases, the adapter can be retrofit to existing turbomachines in the field and/or can salvage components that have incorrect radial teeth manufacturing.

FIG. 4 depicts a schematic view of a rotor assembly 100 having an adapter 30 according to embodiments of the present invention. The rotor assembly 100 is a part of a turbomachine that is used for the compression of a gas or liquid. The rotor assembly 100, as shown, includes a first rotatable component 10, a tie-bolt 18, a second rotatable component 20, and an adapter 30. The first rotatable component 10 is operably coupled to the second rotatable component 20 via the adapter 30 and the tie-bolt 18 such that rotation of one rotatable component 10, 20 causes rotation of the other rotatable component 10, 20. For compressor assemblies, the adapter 30 is disposed between the first rotatable component 10 (i.e. impeller) and the second rotatable component 20 (i.e. shaft)so that torque is transmitted from the second rotatable component 20 to the adapter 30, and from the adapter 30 to the first rotatable component 10. For expander assemblies, the adapter 30 is disposed between the first rotatable component 10 (i.e. impeller) and the second rotatable component 20 (i.e. shaft) so that torque is transmitted from the first rotatable component 10 to the adapter 30, and from the adapter 30 to the second rotatable component 10. Embodiments of the rotor assembly 100 may also include more than two rotatable components, such as an impeller operably coupled to both ends of a rotating shaft.

FIG. 5 depicts a schematic view of the first rotatable component 10 of the rotor assembly 100, in accordance with embodiments of the present invention. The first rotatable component 10 include a recess 13 that accommodates the adapter 30. The recess 13 is defined by a radial surface 15 and an axial surface 16. The radial surface 15 extends radially outward from a central axis 9 of the rotor assembly 100 while the axial surface 15 extends axially along the central axis 9 of the rotor assembly 100. The first rotatable component 10 includes a central axial opening 11 that extends through the first rotatable component 11 along the central axis 9 of the rotor assembly 100. The opening 11 is sized and dimensioned to receive the tie-bolt 18 for securing the first rotatable component 10, the adapter 30, and the second rotatable component 20 together to form the rotor assembly 100. In an exemplary embodiment, the first rotatable component 10 is an impeller; the impeller includes blades or vanes and may be an open type impeller or a closed type impeller.

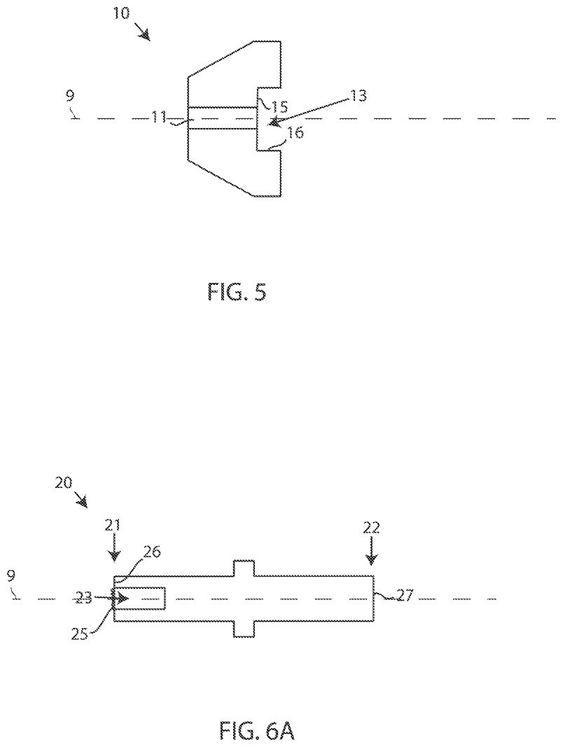

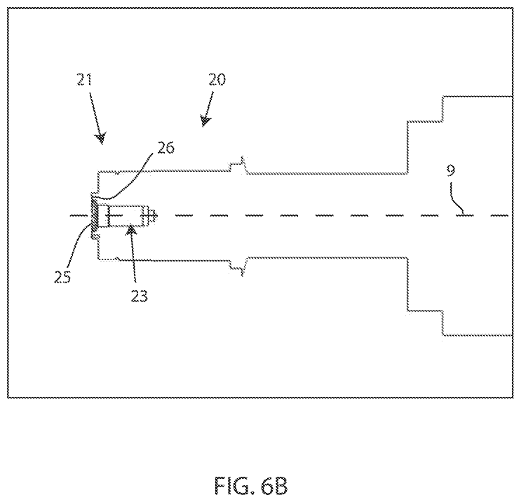

FIG. 6A depicts a schematic view of the second rotatable component 20 of the rotor assembly 100, in accordance with embodiments of the present invention. The second rotatable component 20 includes a first end 21 and a second end 22, which is a distal end from the first end 21. A recess 23 is located at the first end 21, which is configured to receive a portion of the tie-bolt 18 that extends through the first rotatable component 10 and the adapter 30 to secure the first rotatable component 10, the adapter 30, and the second rotatable component 20 together to form the rotor assembly 100. The second rotatable component 20 includes an end face 26 that faces the adapter 30. The end face 26 includes teeth 25 which form part of the radial tooth joint. The teeth 25 extend axially from the end face 26 and are configured to mesh with teeth of the adapter 30 to transmit torque between the second rotatable component 20 and the adapter 30. Moreover, the second rotatable component 20 illustrated in FIG. 6A shows an end face 27 at the second end 22 that does not have a rotatable component (e.g. an impeller) mounted thereon, and no recess for receiving a portion of a tie-bolt. However, in other embodiments described in greater detail infra, an additional rotatable component can be mounted on the second rotatable component 20 at the second end 22, and the end face 27 may have a recess for receiving a tie-bolt and may be configured to transmit torque therebetween by any of the aforementioned methods. In an exemplary embodiment, the second rotatable component 20 is a shaft; the shaft can be a pinion shaft as used with integrally geared compressors, with one or more pinion formed on the shaft for meshing with other pinions of a compressor.

FIG. 6B depicts a cross-sectional view of the second rotatable component 20, in accordance with embodiments of the present invention. The first end 21 of the second rotatable component 20 depicted in FIG. 6B. The recess 23 is located at the first end 21, which is configured to receive a portion of the tie-bolt 18 that extends through the first rotatable component 10 and the adapter 30 to secure the first rotatable component 10, the adapter 30, and the second rotatable component 20 together to form the rotor assembly 100. The end face 26 faces the adapter 30 and includes teeth 25 which form part of the radial tooth joint and mesh with radial teeth of the adapter 30 to transmit torque between the second rotatable component 20 and the adapter 30.

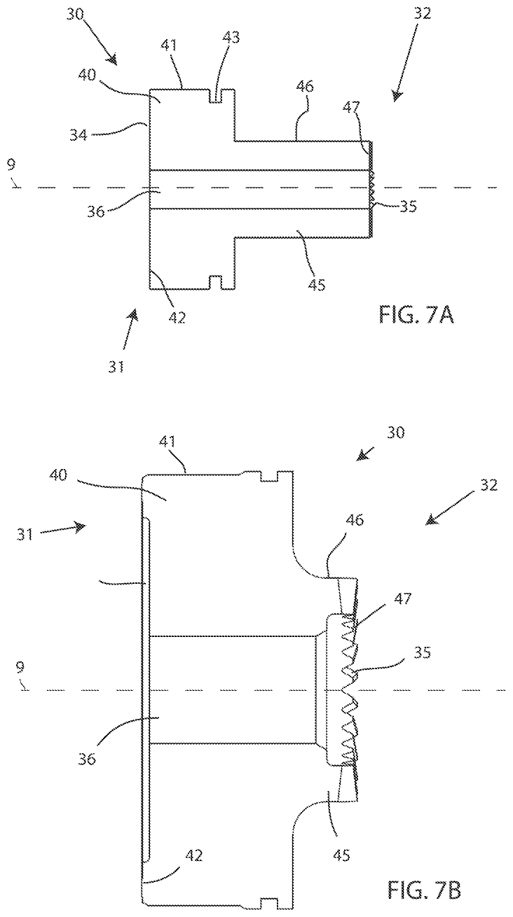

With continued reference to the drawings, FIG. 7A depicts a schematic view of the adapter 30 of the rotor assembly 100, in accordance with embodiments of the present invention. The adapter 30 transmits torque between the first rotatable component 10 and the second rotatable component 20. The adapter 30 includes a first torque transmission feature configured to transmit torque between the adapter 30 and the first rotatable component 10. The first torque transmission feature is located at a first end 31 of the adapter 30 that is proximate the first rotatable component 10, in an assembled configuration. For instance, the first torque transmission feature of the adapter 30 is configured to engage a surface of the first rotatable component 10, such as axial surface 15 of the first rotatable component 10 and/or radial surface 16 of the first rotatable component 10. In embodiments where a shim is used, explained in more detail infra, the first torque transmission feature is configured to engage the shim placed between the adapter 30 and the first rotatable component 10. The first torque transmission feature can be a precision friction connection between the end of the adapter 30 and the radial surface 16 and/or the axial surface 15 of the first rotatable component 10. The first torque transmission feature can also be a mechanical connection, such as a keyed connection, an axial spline, one or more pins, a taper, or a polygonal connection.

The adapter 30 also includes a second torque transmission feature configured to transmit torque between the adapter 30 and the second rotatable component 20. The second torque transmission feature is located at a second end 32 of the adapter 30 that is proximate the second rotatable component 20, in an assembled configuration. For instance, the second torque transmission feature of the adapter 30 is configured to engage a surface of the second rotatable component 20 such as the end face 26 of the second rotatable component 20. The second torque transmission feature is different than the first torque transmission feature. In an exemplary embodiment, the second torque transmission feature is a radial tooth joint between the second end 32 of the adapter 30 and the end face 26 of the second rotatable component 20.

FIG. 7B depicts a cross-sectional view of an adapter, in accordance with embodiments of the present invention. The adapter 30 includes a first torque transmission feature located at a first end 31 of the adapter 30 that is proximate the first rotatable component 10, in an assembled configuration; the first torque transmission feature in the embodiment shown in FIG. 7B is a precision friction connection. The adapter 30 also includes the second torque transmission feature located at a second end 32 of the adapter 30 that is proximate the second rotatable component 20, in an assembled configuration. The second torque transmission feature is a radial tooth joint between the second end 32 of the adapter 30 and the end face 26 of the second rotatable component 20.

As illustrated in FIGS. 7A and 7B, the adapter 30 includes a first annular body portion 40 having a diameter and including an outer surface 41 extending in an axial direction, and an end face 34 extending in a radial direction that faces the first rotatable component 10. The end face 34 includes surface features, such as a microspline, to enable the first torque transmission feature.

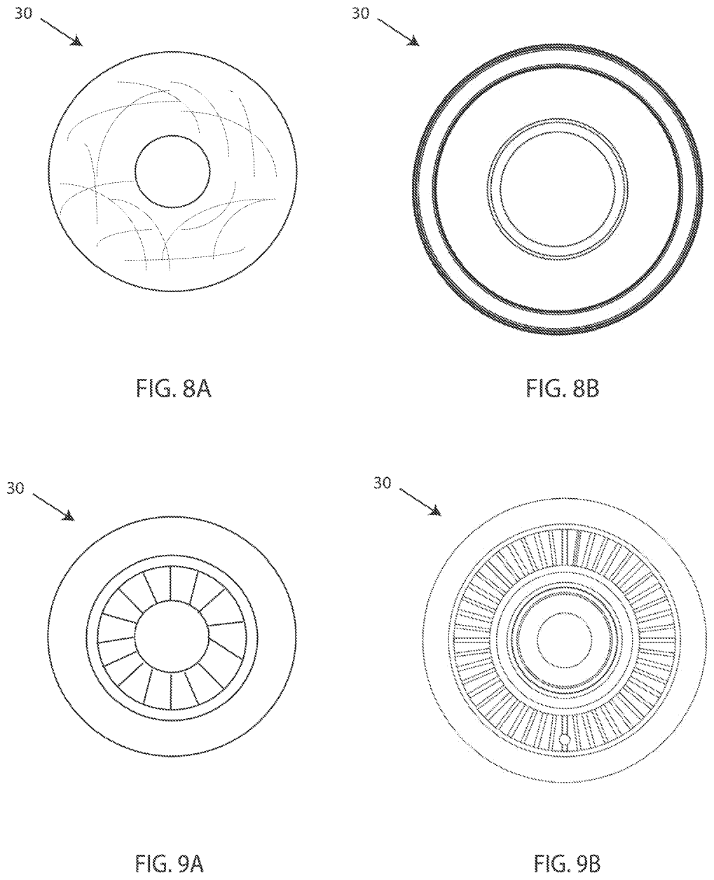

FIG. 8A depicts an end view of the adapter 30 depicted in FIG. 7A, showing a first embodiment of the first torque transmission feature, in accordance with embodiments of the present invention. The first torque transmission feature can be a microspline or similar precision friction fit whereby known materials and precision surface finishes result in known and repeatable coefficients of friction which in combination with an accurate preload produce a known amount of torque carrying capacity. FIG. 8B depicts an end view of the adapter 30 depicted in FIG. 7B, showing a first embodiment of the first torque transmission feature, in accordance with embodiments of the present invention. The first torque transmission feature is a microspline or similar precision friction fit whereby known materials and precision surface finishes result in known and repeatable coefficients of friction which in combination with an accurate preload produce a known amount of torque carrying capacity.

The adapter 30 also includes a second annular body portion 45 structurally integral with the first annular body portion 40. In the illustrated embodiment, the second annular body portion 45 has a diameter smaller than the diameter of the first annular body portion 40, and includes an outer surface 46 extending in the axial direction, and an end face 47 extending in the radial direction that faces the shaft 20. In other embodiments, the diameter of the second annular body portion 45 is larger than the diameter of the first annular body portion 40, or the diameters of the body portions 40, 45 can be the same. The end face 47 includes a portion of the radial tooth joint, including teeth 35 that mesh with teeth 25 located on the end face 26 of the second rotatable component 20, to enable the second torque transmission feature. FIG. 9A depicts an end view of the adapter 30 depicted in FIG. 7A, showing the second torque transmission feature, in accordance with embodiments of the present invention. The teeth 35 are tapered teeth that protrude from the end face 37 of the adapter 30 and are precisely machined to mesh with corresponding tapered teeth 25 on the end face 26 of the second rotatable component 20. Because the teeth 25, 35 mesh, as the second rotatable component 20 rotates, the adapter 30 likewise rotates, and thus torque is transferred between the second rotatable component 20 to the adapter 30. FIG. 9B depicts an end view of the adapter 30 depicted in FIG. 7B, showing the second torque transmission feature, in accordance with embodiments of the present invention. The teeth 35 are tapered teeth that protrude from the end face 37 of the adapter 30 and are precisely machined to mesh with corresponding tapered teeth 25 on the end face 26 of the second rotatable component 20. Because the teeth 25, 35 mesh, as the second rotatable component 20 rotates, the adapter 30 likewise rotates, and thus torque is transferred between the second rotatable component 20 to the adapter 30.

Optionally, the adapter 30 includes an annular groove 43 in the outer surface 41 of the first annular body portion 40. The annular groove configured to receive a seal, such an O-ring, for sealing against a surface of the impeller 10 to seal against corrosive process gases.

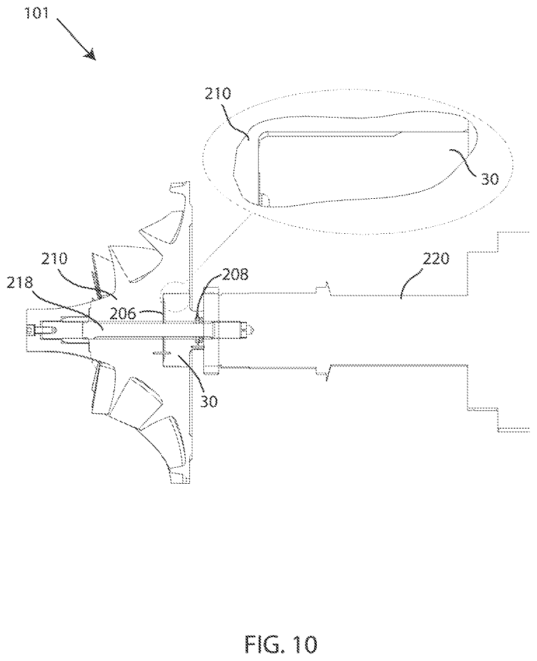

While the adapter can be used in a rotor assembly for different types of turbomachines, pumps, etc., FIG. 10 depicts an embodiment of a centrifugal compressor rotor assembly having the adapter according to embodiments of the invention. Specifically, FIG. 10 depicts a cross-sectional view of a compressor assembly 101 including the adapter 30, in accordance with embodiments of the present invention. The compressor assembly 101 includes an impeller 210 operably coupled to a rotating shaft 220 via adapter 30. The adapter is disposed between the impeller 210 and the shaft 220 to facilitate torque transmission from the shaft 220 to the impeller 210. The adapter 30 mechanically engages the impeller 210 with a mechanical or precision fit connection 206 and mechanically engages the shaft 220 with a radial tooth joint 208. Tie bolt 218 is inserted through the impeller 210, adapter 30, and at least a portion of the shaft 220 to secure the components together to form a rotor assembly of the compressor assembly 101. During operation of the compressor assembly 101, the shaft 220 is driven by a drive unit and/or gear system to cause rotation of the adapter 30, which in turn causes rotation of the impeller 210. For expanders having a similar rotor assembly as compressor assembly 101, the impeller 210 causes rotation of the adapter 30, which in turn causes rotation of the shaft 220.

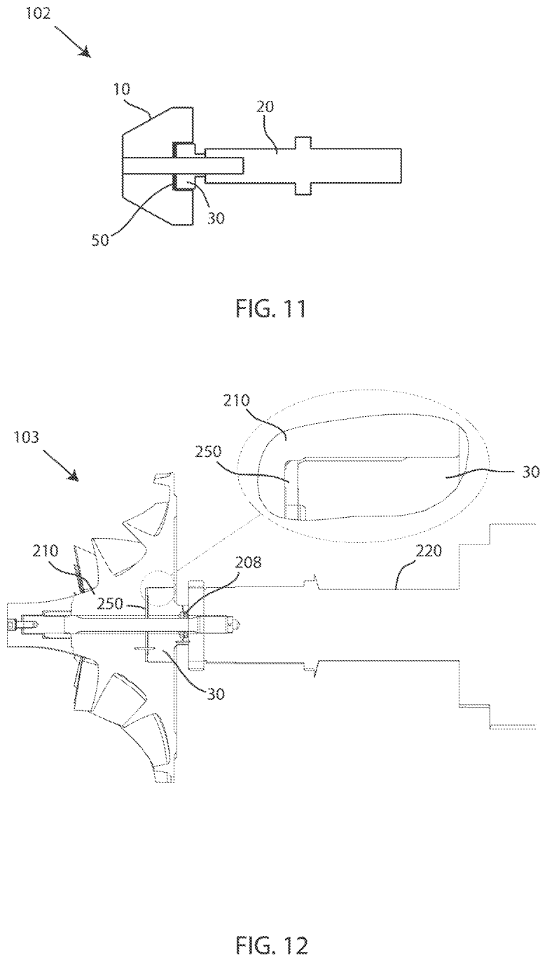

FIG. 11 depicts a schematic view of a rotor assembly 102 including the adapter 30 and a shim 50, in accordance with embodiments of the present invention. The shim 50 is used to adjust an axial position of the first rotatable component 10 (e.g. impeller), for example, for clearance inside a compressor housing. The shim 50 is placed in between the adapter 30 and the first rotatable component 10, which adjusts the axial position of the first rotatable component 10. The shim 50 cooperates with the friction fit connection between the first rotatable component 10 and the adapter. For instance, the shim 50 may have a friction face area that is equal to a friction face area of the adapter 30 facing the first rotatable component 10.

While the adapter can be used in a rotor assembly for different types of turbomachines, pumps, etc., FIG. 12 depicts an embodiment of a centrifugal compressor rotor assembly having the adapter and a shim according to embodiments of the invention. Specifically, FIG. 12 depicts a cross-sectional view of a compressor assembly 103 including the adapter 30 and shim 250, in accordance with embodiments of the present invention. The compressor assembly 103 shares the same structural configuration of compressor assembly 102 of FIG. 11 except that a shim 250 is positioned between the adapter 30 and the impeller 210.

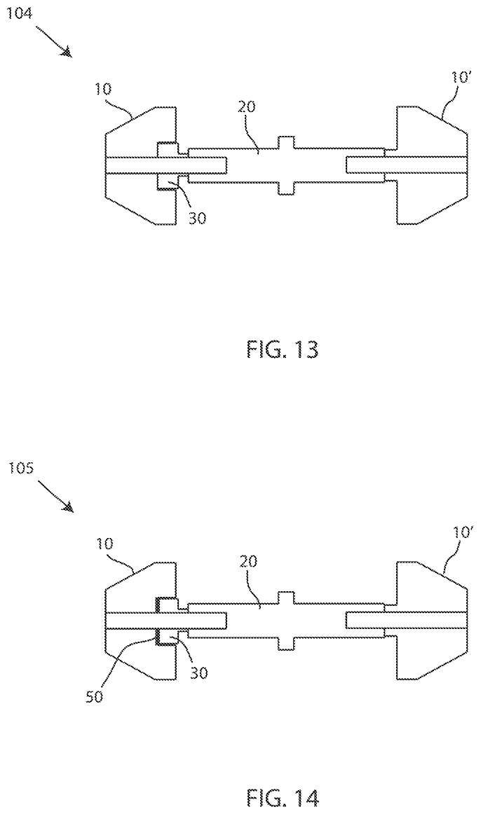

FIG. 13 depicts a schematic view of a rotor assembly 104 including the adapter 30, with an additional rotatable component, in accordance with embodiments of the present invention. The rotor assembly 104 shares the same structural configuration as rotor assembly 100 of FIG. 4 except that an additional rotatable component 10′ is operably coupled to the second rotatable component 20. The rotor assembly 104 includes an adapter 30 between the first rotatable component 10 and the second rotatable component 20, while the opposing side of the rotor assembly 104 includes an additional rotatable component 10′ operably coupled to the second rotatable component 20 according to conventional methods.

FIG. 14 depicts a schematic view of a rotor assembly 105 including the adapter 30 with an additional rotatable component 10′ and a shim 50 on one side of the rotor assembly 105, in accordance with embodiments of the present invention. The rotor assembly 105 shares the same structural configuration as rotor assembly 104 of FIG. 13 except that a shim 50 is disposed between the adapter 30 and the first rotatable component 10 to adjust an axial position of the first rotatable component 10. The opposing side of the rotor assembly 104 includes an additional rotatable component 10′ operably coupled to the second rotatable component 20 according to conventional methods.

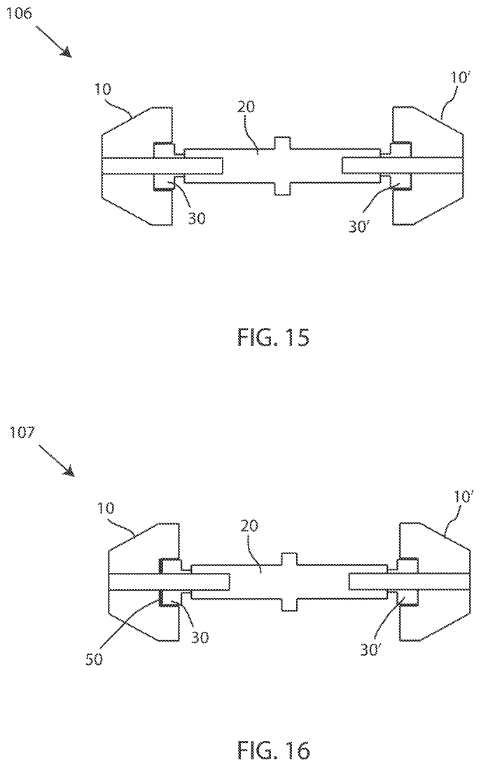

FIG. 15 depicts a schematic view of a rotor assembly including two adapters, one of each side of the rotor assembly 106, in accordance with embodiments of the present invention. The rotor assembly 106 shares the same structural configuration as rotor assembly 104 of FIG. 13 except that an additional adapter 30′ is disposed between the additional rotatable component 10′ operably coupled to the second rotatable component 20. The rotor assembly 106 includes two adapters 30, 30′ on both sides of the rotor assembly 106.

FIG. 16 depicts a schematic view of a rotor assembly 107 including two adapters 30, 30′, one of each side of the assembly 107, and a shim 50 on one side of the assembly 107, in accordance with embodiments of the present invention. The rotor assembly 107 shares the same structural configuration as rotor assembly 106 of FIG. 15 except that a shim 50 is disposed between the adapter 30 and the first rotatable component 10 to adjust an axial position of the first rotatable component 10. The opposing side of the rotor assembly 104 includes an additional rotatable component 10′ operably coupled to the second rotatable component 20 and an additional adapter 30′ without a shim 50. Further, embodiments of the rotor assembly 107 may include a shim 50 on both sides of the assembly.

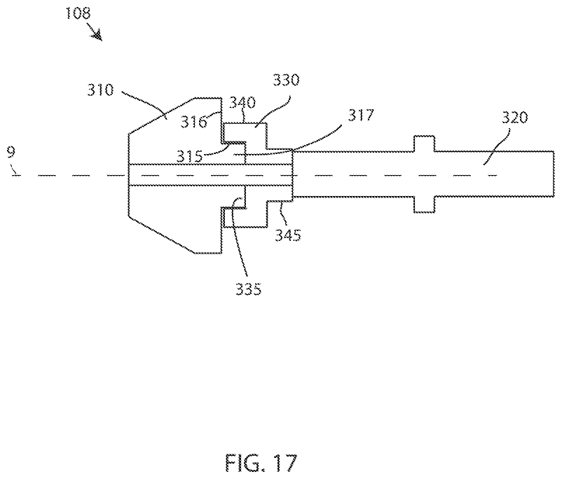

FIG. 17 depicts a schematic view of a rotor assembly 108 including an adapter 330 according to an alternative embodiment. The adapter 330 transmits torque between the first rotatable component 310 and the second rotatable component 320. The adapter 330 includes a first torque transmission feature configured to transmit torque between the adapter 330 and the first rotatable component 310. The first torque transmission feature is proximate the first rotatable component 310, in an assembled configuration. For instance, the first torque transmission feature of the adapter 330 is configured to engage a surface of the first rotatable component 310, such as axial surface 315 of the first rotatable component 310 and/or radial surface 316 of the first rotatable component 310. The first torque transmission feature can be a precision friction connection between the end of the adapter 30 and the radial surface 316 and/or the axial surface 315 of the first rotatable component 310. The first torque transmission feature can also be a mechanical connection, such as a keyed connection, an axial spline, one or more pins, a taper, or a polygonal connection.

The adapter 330 also includes a second torque transmission feature configured to transmit torque between the adapter 330 and the second rotatable component 320. The second torque transmission feature is proximate the second rotatable component 320, in an assembled configuration. For instance, the second torque transmission feature of the adapter 330 is configured to engage a surface of the second rotatable component 320 such as the end face of the second rotatable component 320. The second torque transmission feature is different than the first torque transmission feature. In an exemplary embodiment, the second torque transmission feature is a radial tooth joint between the second end of the adapter 330 and the end face of the second rotatable component 320. As illustrated in FIG. 17, the adapter 330 has an inverse structure to adapter 30 in that the adapter 330 includes a recess 335. The first rotatable component 310 has a corresponding protrusion 317 configured to fit within the recess 335 of the adapter 330. The adapter 330 includes a first annular body portion 340 having a diameter and including an outer surface extending in an axial direction, and an end face extending in a radial direction that faces the first rotatable component 310. The end face includes surface features, such as a microspline, to enable the first torque transmission feature. The adapter 330 also includes a second annular body portion 345 structurally integral with the first annular body portion 340. In the illustrated embodiment, the second annular body portion 345 has a diameter smaller than the diameter of the first annular body portion 340, and includes an outer surface extending in the axial direction, and an end face extending in the radial direction that faces the second rotatable component 320. In other embodiments, the diameter of the second annular body portion 345 is larger than the diameter of the first annular body portion 340, or the diameters of the body portions 340, 345 can be the same. The end face includes a portion of the radial tooth joint, including teeth that mesh with teeth located on the end face of the second rotatable component 320, to enable the second torque transmission feature.

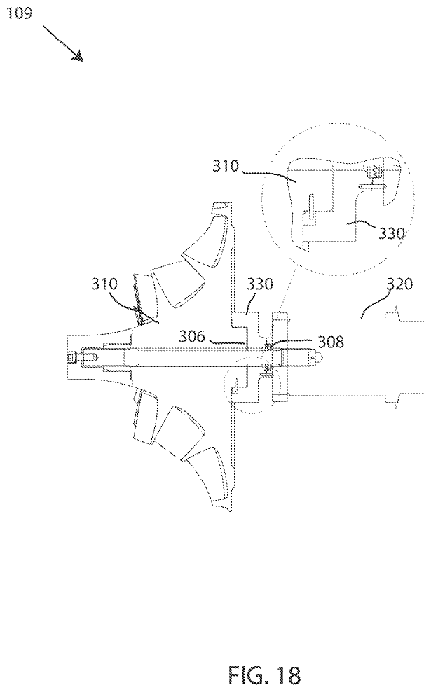

While the adapter 330 can be used in a rotor assembly for different types of turbomachines, pumps, etc., Specifically, FIG. 18 depicts a cross-sectional view of a compressor assembly 109 including the adapter 330, in accordance with embodiments of the present invention. The compressor assembly 109 includes an impeller 310 operably coupled to a rotating shaft 320 via adapter 330. The adapter 330 is disposed between the impeller 310 and the shaft 320 to facilitate torque transmission from the shaft 320 to the impeller 310. The adapter 330 mechanically engages the impeller 310 with a mechanical or precision fit connection 306 and mechanically engages the shaft 320 with a radial tooth joint 308. Tie bolt 318 is inserted through the impeller 310, adapter 330, and at least a portion of the shaft 320 to secure the components together to form a rotor assembly of the compressor assembly 109. During operation of the compressor assembly 109, the shaft 320 is driven by a drive unit and/or gear system to cause rotation of the adapter 330, which in turn causes rotation of the impeller 310. For expanders having a similar rotor assembly as compressor assembly 109, the impeller 310 causes rotation of the adapter 330, which in turn causes rotation of the shaft 320.

Referring now to FIGS. 1-18, a method according to embodiments of the present invention includes disposing an adapter 30, 330 between a first rotatable component 10, 210, 310 and a second rotatable component 20, 220, 320 for transmitting torque between the first rotatable component 10, 210, 310 and the second rotatable component 20, 220, 320, the adapter 30, 330 including a first torque transmission feature located at a first end of the adapter 30, 330 that is proximate the first rotatable component 10, 210, 310, and a second torque transmission feature located at a second end of the adapter 30, 330 that is proximate the second rotatable component 20, 220, 320, wherein the first torque transmission feature is different than the second torque transmission feature.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

What is claimed is:

1. An adapter for torque transmission between a first rotatable component and a second rotatable component, the adapter comprising:
a first torque transmission feature configured to transmit torque between the adapter and the first rotatable component; and
a second torque transmission feature configured to transmit torque between the adapter and the second rotatable component, the second torque transmission feature being different than the first torque transmission feature.

2. The adapter of claim 1, wherein the first torque transmission feature is a precision friction connection.

3. The adapter of claim 1, wherein the first torque transmission feature is a keyed connection, an axial spline, one or more pins, a taper, or a polygonal connection.

4. The adapter of claim 1, wherein the second torque transmission feature is a radial tooth joint.

5. The adapter of claim 1, wherein the first rotatable component is an impeller and the second rotatable component is a shaft.

6. The adapter of claim 1, wherein the first torque transmission feature is located at a first end of the adapter that is proximate the first rotatable component in an assembled configuration, and the second torque transmission feature is located at a second end, opposite the first end, which is proximate the second rotatable component.

7. The adapter of claim 1, wherein the first torque transmission features cooperates with a shim placed between the adapter and the first rotatable component.

8. The adapter of claim 1, further comprising a central axial opening extending through the adapter, the central opening configured to accept a tie bolt for securing the adapter in place.

9. The adapter of claim 1, further comprising:
a first annular body portion having a diameter and including an outer surface extending in an axial direction, and an end face extending in a radial direction that faces the first rotatable component, wherein the first torque transmission feature is located on the end face; and
a second annular body portion having a diameter different than the diameter of the first annular body portion, and including an outer surface extending in the axial direction, and an end face extending in the radial direction that faces the second rotatable component, wherein the second torque transmission feature is located on the end face.

10. The adapter of claim 9, further comprising a groove in the outer surface of the first annular body portion, the groove configured to receive a seal for sealing against a surface of the first rotatable component.

11. An assembly comprising:
a first rotatable component;
a second rotatable component operably coupled to the first rotatable component; and
an adapter disposed between the first rotatable component and the second rotatable component to transmit torque therebetween, the adapter having a first torque transmission feature located at a first end of the adapter that is proximate the first rotatable component, and a second torque transmission feature located at a second end of the adapter that is proximate the second rotatable component, wherein the first torque transmission feature is different than the second torque transmission feature.

12. The compressor of claim 11, a shim disposed between the first end of the adapter and the first rotatable component, the shim configured to cooperate with the first torque transmission feature to transmit torque from the adapter to the first rotatable component.

13. The compressor of claim 11, further compressor an additional rotatable component operably coupled to the second rotatable component at a distal end of the second rotatable component from the first rotatable component.

14. The compressor of claim 13, further comprising an additional adapter disposed between the distal end of the second rotatable component and the additional rotatable component.

15. The compressor of claim 11, further comprising a tie bolt insertable through the first rotatable component to secure the adapter in place between the first rotatable component and the second rotatable component.

16. The compressor of claim 11, wherein the first torque transmission feature is a friction connection.

17. The compressor of claim 11, wherein the second torque transmission feature is a radial tooth joint.

18. A method comprising:
disposing an adapter between a first rotatable component and a second rotatable component for transmitting torque between the first rotatable component and the second rotatable component, the adapter including a first torque transmission feature located at a first end of the adapter that is proximate the first rotatable component, and a second torque transmission feature located at a second end of the adapter that is proximate the second rotatable component, wherein the first torque transmission feature is different than the second torque transmission feature.

19. The method of claim 18, further comprising inserting a shim between the adapter and the first rotatable component to adjust an axial length.

20. The method of claim 18, further comprising inserting a tie bolt through the first rotatable component, the adapter, and the second rotatable component to secure a connection between the first rotatable component, the adapter, and the second rotatable component.
